(19) United States
(12) Patent Application Publication
(10) Pub. No.: US 2022/0179286 A1
(43) Pub. Date: Jun. 9, 2022

(54) LENS DRIVE DEVICE AND ELECTRONIC TERMINAL

(71) Applicant: Changzhou AAC Raytech Optronics Co., Ltd., Changzhou City (CN)

(72) Inventors: Feng Yan, Shenzhen (CN); Suohe Wei, Shenzhen (CN); Gang Li, Shenzhen (CN); Tianheng Ni, Shenzhen (CN)

(21) Appl. No.: 17/543,667

(22) Filed: Dec. 6, 2021

(30) Foreign Application Priority Data
Dec. 8, 2020 (CN) 202022909053.9

(51) Int. Cl. G03B 5/00; G03B 17/12; H04N 5/232; H04N 5/225

(52) U.S. Cl. CPC G03B 5/00; G03B 17/12; G03B 2205/0069; H04N 5/2253; H04N 5/23287

(57) ABSTRACT

A lens drive device and an electronic terminal are provided. The lens drive device includes a housing, a holder, permanent magnets, a lens barrel, a drive coil, an elastic assembly, and a circuit board assembly. The lens barrel is arranged in the holder in such a way that the lens barrel is movable in an optical axis direction of the lens. The elastic assembly is connected to the lens barrel and the holder separately and is used for supporting the lens barrel to move in the optical axis direction. The whole stroke of the lens barrel is increased so that the lens drive device of the present invention has a better performance. It is also possible to reduce the thickness of the lens drive device of the present invention with the stroke unchanged, such that the structure is more compact.

### TECHNICAL FIELD

The present invention relates to the field of lens modules for cameras, and in particular to a lens drive device and an electronic terminal.

### BACKGROUND

For some lens drive devices in the related art, a lens barrel and a holder have basically the same thickness, and the surface of the lens barrel for connecting the elastic piece is arranged, in an optical axis direction, flush with the surface of the holder for connecting the elastic piece, so that the stroke of the lens barrel is too small with a given thickness of the holder, resulting in poor performance, or that the thickness of the lens drive device is too large with a given stroke, which is not conducive to promoting the use of the lens drive devices in equipment.

Therefore, there is a need to provide a novel lens drive device and electronic terminal to solve the above problems.

### SUMMARY

An objective of the present invention is to provide a lens drive device and an electronic terminal, which lens drive device has a larger stroke and a better performance.

In a technical scheme of the present invention, provided is a lens drive device, including:

a housing having a receiving space;

a holder received and fixed in the receiving space;

permanent magnets fixed to the holder;

a lens barrel for receiving a lens, the lens barrel being arranged in the holder in such a way that the lens barrel is movable in an optical axis direction of the lens;

a drive coil fitted over an outer peripheral face of the lens barrel and opposite the permanent magnets fixed to the holder;

an elastic assembly connected to the lens barrel and the holder separately and used for supporting the lens barrel to move in the optical axis direction; and

a circuit board assembly received and fixed in the receiving space and electrically connected to the drive coil,

where the lens barrel includes a first surface connected to the elastic assembly and close to an object side, and the holder includes a second surface connected to the elastic assembly and close to the object side, the second surface being closer to the object side than the first surface; and the lens barrel includes a third surface connected to the elastic assembly and close to an image side, and the holder includes a fourth surface connected to the elastic assembly and close to the image side, the fourth surface being closer to the image side than the third surface.

As an embodiment of the present invention, the elastic assembly includes an upper elastic piece and a lower elastic piece, where the upper elastic piece is connected to the lens barrel and the holder separately, and the lower elastic piece is connected to the lens barrel and the holder separately.

As an embodiment of the present invention, the upper elastic piece includes a first upper connection portion fixed to the second surface, a second upper connection portion fixed to the first surface, and an upper elastic arm for connecting the first upper connection portion and the second upper connection portion; and

the lower elastic piece includes a first lower connection portion fixed to the fourth surface, a second lower connection portion fixed to the third surface, and a lower elastic arm for connecting the first lower connection portion and the second lower connection portion.

As an embodiment of the present invention, the housing includes a base and an upper cover covering and connected to the base, where the base and the upper cover enclose and form the receiving space; the circuit board assembly includes a flexible printed circuit board (PCB) arranged on the base, and a PCB arranged on the flexible PCB in a stacked manner and electrically connected to the flexible PCB; and the flexible PCB is welded to the base.

As an embodiment of the present invention, the flexible PCB is provided with a plated through hole electrically connected to the PCB.

As an embodiment of the present invention, the lens drive device further includes an image stabilization coil electrically connected to the PCB, the image stabilization coil is embedded inside the PCB and arranged opposite the permanent magnets, and the PCB is arranged in parallel with the base.

As an embodiment of the present invention, the lens drive device further includes a metal pin fixed to the housing and welded to the circuit board assembly, and a suspension wire for connecting the upper elastic piece and the metal pin.

As an embodiment of the present invention, the metal pin is integrally formed with the housing.

As an embodiment of the present invention, the lens drive device further includes a Hall sensor welded to the circuit board assembly and used for measuring an amount of movement of the lens.

In another technical scheme of the present invention, provided is an electronic terminal including a terminal body and a lens drive device as described in any of the above embodiments, where the lens drive device is arranged on the terminal body.

The present invention has the following beneficial effects.

In the lens drive device of the present invention, the lens barrel includes a first surface connected to the elastic assembly and close to an object side, and the holder includes a second surface connected to the elastic assembly and close to the object side. The second surface is closer to the object side than the first surface, so that the stroke of the lens barrel in the direction of the object side becomes larger. The lens barrel includes a third surface connected to the elastic assembly and close to an image side, and the holder includes a fourth surface connected to the elastic assembly and close to the image side. The fourth surface is closer to the image side than the third surface, so that the stroke of the lens barrel in the direction of the image side becomes larger. Therefore, the whole stroke of the lens barrel becomes larger and the lens drive device in this embodiment has a better performance. Similarly, it is also possible to reduce the thickness of the lens drive device in this embodiment with the stroke unchanged, such that the structure is more compact.

### BRIEF DESCRIPTION OF DRAWINGS

FIG. 1 is a schematic view of the overall structure of a lens drive device according to an embodiment of the present invention;

FIG. 2 is a schematic exploded view of the lens drive device in FIG. 1;

FIG. 3 is a schematic view of the structure of a holder in FIG. 1;

FIG. 4 is a schematic view of the structure of an upper elastic piece in FIG. 1;

FIG. 5 is a schematic view of the structure of a lower elastic piece in FIG. 1;

FIG. 6 is a schematic view of the structure in which a lens barrel and the holder in FIG. 1 are assembled together;

FIG. 7 is a schematic view of the structure in which the lens barrel and the holder in FIG. 1 are assembled together from another perspective;

FIG. 8 is a cross-sectional view taken along line A-A in FIG. 7; and

FIG. 9 is a schematic view of the overall structure of an electronic terminal according to an embodiment of the present invention.

1. Lens drive device; 2. Terminal body; 100. Housing; 101. Receiving space; 110. Base; 111. First light-transmitting hole; 112. Metal pin; 120. Upper cover; 121. Upper wall; 1211. Second light-transmitting hole; 122. Side wall; 200. Holder; 201. Second surface; 202. Fourth surface; 210. Mounting groove; 300. Permanent magnet; 400. Lens barrel; 401. Lens receiving hole; 402. First surface; 403. Third surface; 410. Annular groove; 500. Drive coil; 600. Elastic assembly; 610. Upper elastic piece; 611. First upper connection portion; 612. Second upper connection portion; 613. Upper elastic arm; 620. Lower elastic piece; 621. First lower connection portion; 622. Second lower connection portion; 623. Lower elastic arm; 630. Suspension wire; 700. Circuit board assembly; 710. Flexible printed circuit board (PCB); 711. Plated through hole; 720. PCB; 800. Image stabilization coil; 900. Hall sensor.

### DETAILED DESCRIPTION

For a further description of all embodiments, accompanying drawings are provided in the present invention. The accompanying drawings are part of the content disclosed by the present invention and are mainly used for illustrating the embodiments, and can explain the operating principles of the embodiments in cooperation with the relevant illustration in the description. By referring to the content, those of ordinary skill in the art can understand other possible embodiments and advantages of the present invention. Assemblies in the drawings are not drawn to scale, and similar reference numerals are generally used for indicating similar components.

The present invention will be further explained with reference to the accompanying drawings and the embodiments.

A lens drive device 1 with auto focusing (AF) and optical image stabilization (OIS) functions of the present invention can be applied to portable mobile terminals such as smartphones and tablet computers.

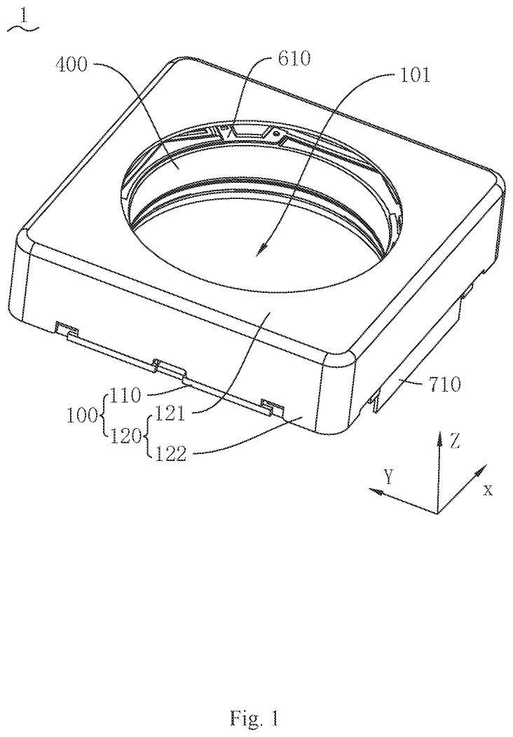

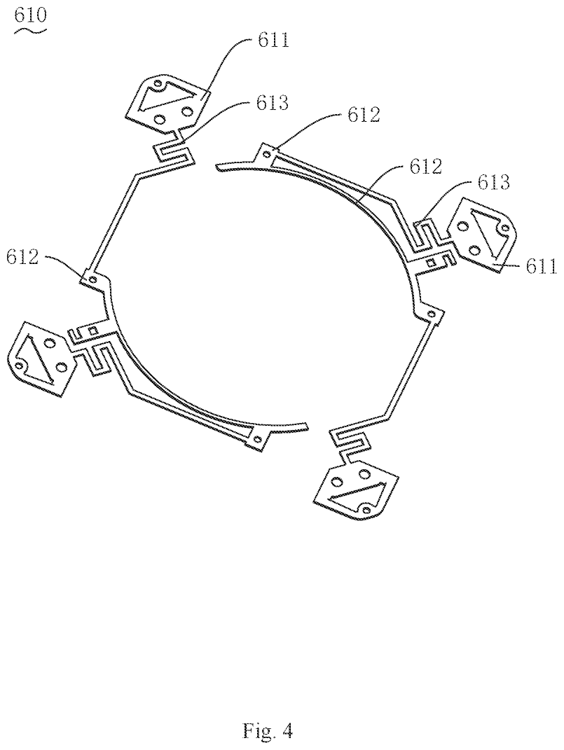

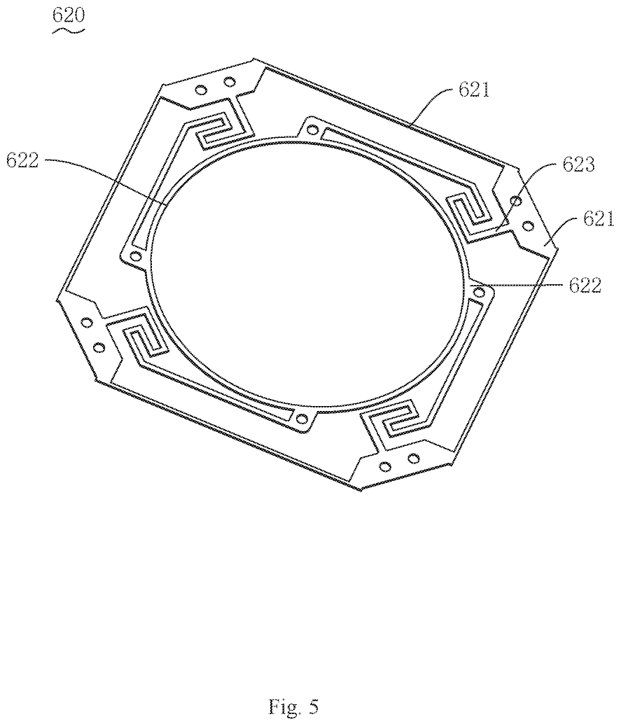

Referring to FIGS. 1-8 (through), an embodiment of the present invention provides a lens drive device 1. The lens drive device 1 in this embodiment includes a housing 100, a holder 200, permanent magnets 300, a lens barrel 400, a drive coil 500, an elastic assembly 600, and a circuit board assembly 700.

Referring to FIG. 1, the housing 100 includes a base 110 and an upper cover 120 covering and connected to the base 110. The upper cover 120 and the base 110 enclose and form a receiving space 101. The base 110 is optionally in the shape of a rectangular plate, and the base 110 has a first light-transmitting hole 111. The upper cover 120 includes a rectangular upper wall 121 and four side walls 122 extending downward from the upper wall 121. A second light-transmitting hole 1211 is formed in the center of the upper wall 121, and the first light-transmitting hole 111 is arranged corresponding to the second light-transmitting hole 1211.

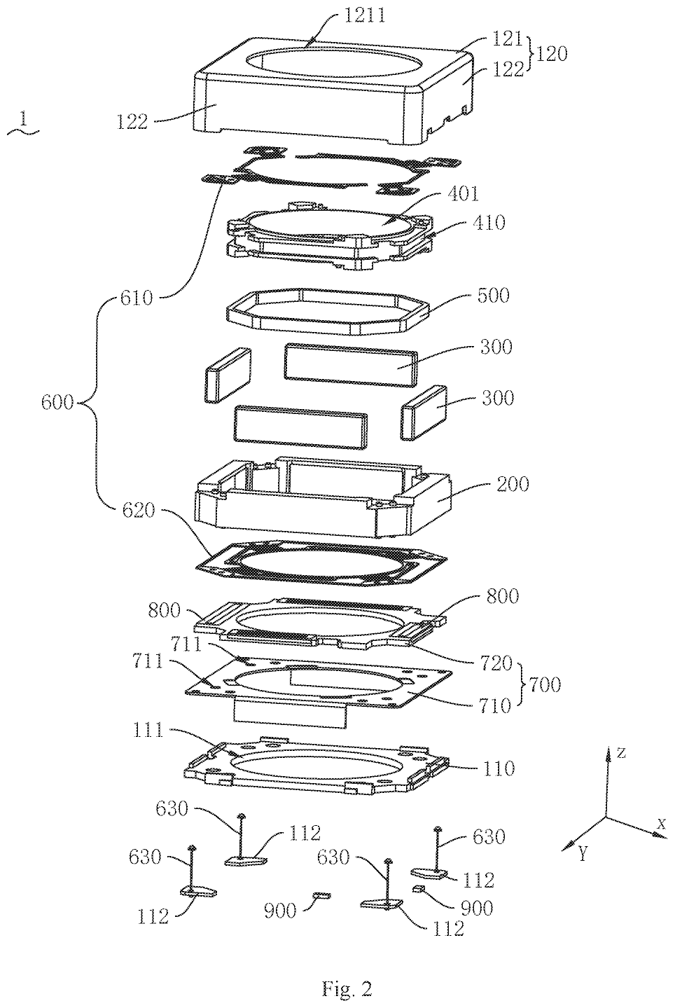

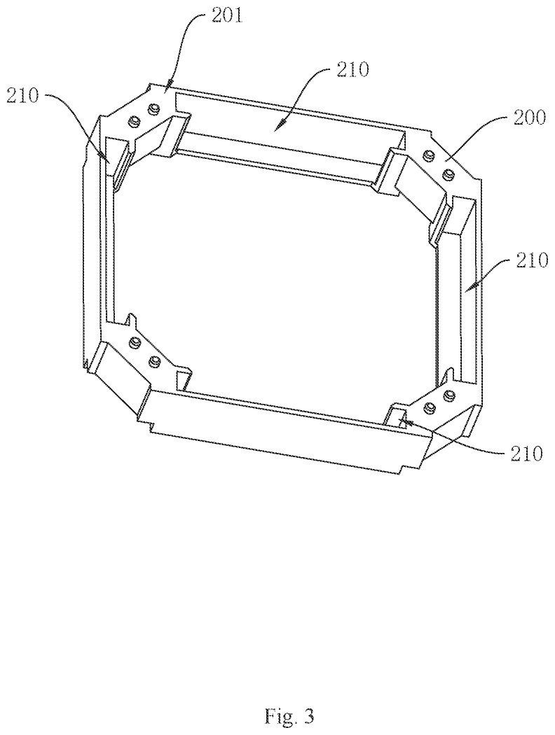

Referring to FIGS. 2 and 3, the holder 200 is a frame surrounding the lens barrel 400. The frame is arranged on the base 110 and received in the receiving space 101, and can move in the receiving space 101 of the housing 100 in directions perpendicular to an optical axis, that is, in all directions within the XY plane.

Referring to FIG. 3, the holder 200 is provided with four mounting grooves 210. The four mounting grooves 210 are arranged on the inner side of the holder 200 facing away from the housing 100 and are arranged opposite each other in two pairs. Each of the permanent magnets 300 is mounted in a respective mounting groove 210.

Referring to FIG. 2, the lens barrel 400 is an annular component with a lens receiving hole 401 in the center, and a lens can be received in the lens receiving hole 401. The lens can move in the receiving space 101 of the housing 100 in an optical axis direction, which is the Z-axis direction in the figure.

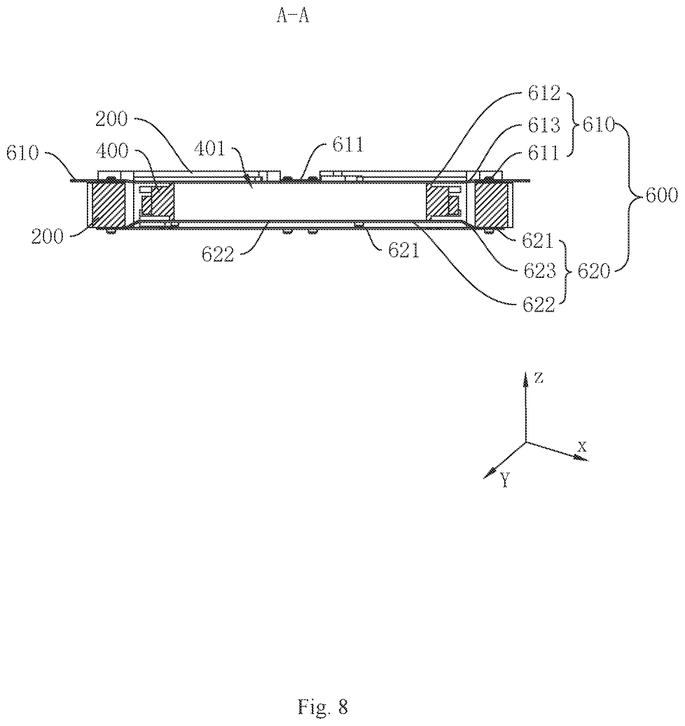

Referring to FIGS. 2 and 8, the lens can be mounted in the lens barrel 400 in this embodiment. The side of the lens facing an object is the object side, and the side opposite the object side and close to an imaging plane is the image side.

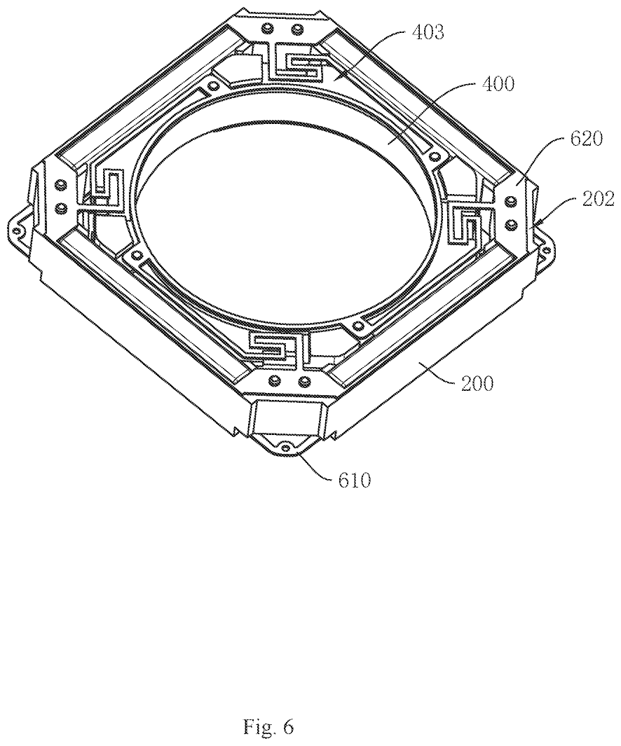

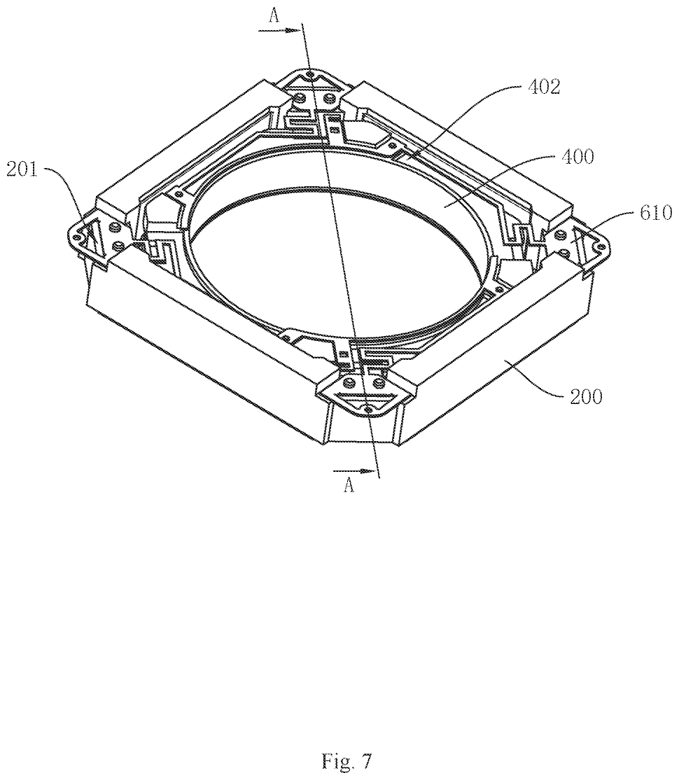

Referring to FIGS. 6 and 7, the lens barrel 400 includes a first surface 402 connected to the elastic assembly 600 and close to the object side, and the holder 200 includes a second surface 201 connected to the elastic assembly 600 and close to the object side. The second surface 201 is closer to the object side than the first surface 402, so that the stroke of the lens barrel 400 in the direction of the object side becomes larger. The lens barrel 400 includes a third surface 403 connected to the elastic assembly 600 and close to the image side, and the holder 200 includes a fourth surface 202 connected to the elastic assembly 600 and close to the image side. The fourth surface 202 is closer to the image side than the third surface 403, so that the stroke of the lens barrel 400 in the direction of the image side becomes larger. Therefore, the whole stroke of the lens barrel 400 becomes larger and the lens drive device 1 in this embodiment has a better performance. Similarly, it is also possible to reduce the thickness of the lens drive device 1 in this embodiment with the stroke unchanged, such that the structure is more compact.

Referring to FIG. 2, the drive coil 500 is fitted over an outer peripheral face of the lens barrel 400 and opposite the permanent magnets 300 fixed to the holder 200.

Specifically, the outer peripheral face of the lens barrel 400 is provided with an annular groove 410, and the drive coil 500 is fitted in the annular groove 410.

Referring to FIGS. 2 and 8, the elastic assembly 600 is connected to the lens barrel 400 and the holder 200 separately and is used for supporting the lens barrel 400 to move in the optical axis direction.

Referring to FIGS. 2 and 8, specifically, the elastic assembly 600 includes an upper elastic piece 610 and a lower elastic piece 620. The upper elastic piece 610 is connected to the lens barrel 400 and the holder 200 separately, and the lower elastic piece 620 is connected to the lens barrel 400 and the holder 200 separately. The lens barrel 400 is supported to move in the optical axis direction under the combined action of the upper elastic piece 610 and the lower elastic piece 620.

Optionally, the upper elastic piece 610 and the lower elastic piece 620 are separately riveted to the holder 200 by means of hot pressing, and the upper elastic piece 610 and the lower elastic piece 620 are separately connected to the lens barrel 400 by means of glue curing.

Referring to FIGS. 2 and 4-8, more specifically, the upper elastic piece 610 includes a first upper connection portion 611 fixed to the second surface 201, a second upper connection portion 612 fixed to the first surface 402, and an upper elastic arm 613 for connecting the first upper connection portion 611 and the second upper connection portion 612. The lower elastic piece 620 includes a first lower connection portion 621 fixed to the fourth surface 202, a second lower connection portion 622 fixed to the third surface 403, and a lower elastic arm 623 for connecting the first lower connection portion 621 and the second lower connection portion 622.

The circuit board assembly 700 is arranged on the base 110 and is electrically connected to the drive coil 500. The motion of the lens barrel 400 is powered by the circuit board assembly 700.

Referring to FIG. 2, specifically, the circuit board assembly 700 includes a flexible printed circuit board (PCB) 710 arranged on a base 110 and a PCB 720 arranged on the flexible PCB 710 in a stacked manner and electrically connected to the flexible PCB 710. The flexible PCB 710 is welded to the base 110. Compared with the mounting of the circuit board assembly 700 in the related art where the circuit board assembly 700 needs to be welded to the base 110 piece by piece, which leads to a complex structure of inserts on the base 110 and greater difficulty in manufacturing, the difficulty in manufacturing can be greatly reduced in this embodiment by combining the PCB 720 with the flexible PCB 710 before welding the flexible PCB 710 to the base 110.

Optionally, the flexible PCB 710 extends at least partially to the outside of the housing so as to be electrically connected to an external power supply.

Referring to FIG. 2, optionally, the flexible PCB 710 is provided with a plated through hole 711, and the plated through hole 711 is electrically connected to the PCB 720. The PCB 720 and the flexible PCB 710 are welded together through the plated through hole 711, and a sealing treatment is then carried out, so that the manufacturing process can be simplified.

Optionally, the PCB 720 is arranged in parallel with the base 110.

Referring to FIG. 2, in an embodiment, the lens drive device 1 further includes a metal pin 112 fixed to the base 110 and welded to the flexible PCB 710, and a suspension wire 630 for connecting the upper elastic piece 610 and the metal pin 112. In this embodiment, the flexible PCB 710 is energized, the metal pin 112 welded thereto conducts electricity, and the current is then conducted to the upper elastic piece 610 through the suspension wire 630. Optionally, the drive coil 500 is electrically connected to the upper elastic piece 610, such that the drive coil 500 interacts with the permanent magnets 300 after being energized, so as to generate a force for driving the lens barrel 400 to move in the optical axis direction.

Of course, the drive coil 500 may also be electrically connected to the flexible PCB 710 or the PCB 720 directly.

Optionally, the metal pin 112 is integrally formed with the base 110.

In a specific embodiment, the object side is the side facing the upper wall 121, and the image side is the side facing the base 110. The distance between the first surface 402 and the upper wall 121 is larger than that between the second surface 201 and the upper wall 121, and the distance between the third surface 403 and the base 110 is larger than that between the fourth surface 202 and the base 110.

Since the first surface 402 is not flush with the second surface 201, the upper elastic piece 610 connected to the lens barrel 400 and the holder 200 is stressed to a certain extent, and the upper elastic piece 610 then has a certain initial deformation after being connected to the lens barrel 400 and the holder 200. Similarly, the lower elastic piece 620 also has a certain initial deformation after being connected to the lens barrel 400 and the holder 200. Accordingly, under the combined action of the upper elastic piece 610 and the lower elastic piece 620, the lens barrel 400 reaches a state of equilibrium.

Optionally, the elastic forces exerted by the upper elastic piece 610 and the lower elastic piece 620 on the lens barrel 400 are equal or similar, so that the stroke of the lens barrel 400 toward the upper wall 121 and the stroke of the lens barrel 400 toward the base 110 are substantially the same. Of course, the elastic forces exerted by the upper elastic piece 610 and the lower elastic piece 620 on the lens barrel 400 can also be adjusted according to actual requirements to change the stroke of the lens barrel 400 toward the upper wall 121 and the stroke of the lens barrel 400 toward the base 110. Specifically, the elastic force exerted by the upper elastic piece 610 on the lens barrel 400 may be changed by changing the height difference between the first surface 402 and the second surface 201, and the elastic force may also be changed by changing the material and shape of the upper elastic piece. The same is true for the lower elastic piece 620.

Referring to FIG. 2, in an embodiment, the lens drive device 1 further includes an image stabilization coil 800 electrically connected to the PCB 720, and the image stabilization coil 800 is embedded inside the PCB 720 and arranged opposite the permanent magnets 300.

Through the interaction between the image stabilization coil 800 and the permanent magnets 300, the holder 200 for having the permanent magnets 300 mounted therein moves in the XY plane under the action of an Ampere force, so that an image stabilization effect can be achieved in the XY plane. In addition, by embedding the image stabilization coil 800 into the PCB 720, the thickness of the PCB 720 can be reduced.

To realize the auto focusing function, the lens drive device 1 is operated as follows. The current flows through the drive coil 500, and the Ampere force is generated between the permanent magnets 300 and the drive coil 500, by which the lens barrel 400 is moved up and down in the optical axis direction in the housing 100. When the current flowing through the drive coil 500 stops, the lens barrel 400 returns to the initial position by elastic restoring forces from the upper elastic piece 610 and the lower elastic piece 620.

Referring to FIG. 2, in an embodiment, the lens drive device 1 further includes a Hall sensor 900 welded to the circuit board assembly 700. The Hall sensor 900 is used for measuring an amount of movement of the lens. Specifically, the Hall sensor 900 senses the jitter of the lens barrel 400, and the lens drive device 1 in this embodiment automatically adjusts the current flowing through the image stabilization coil 800 according to the level of jitter of the lens barrel 400, thereby achieving the image stabilization effect.

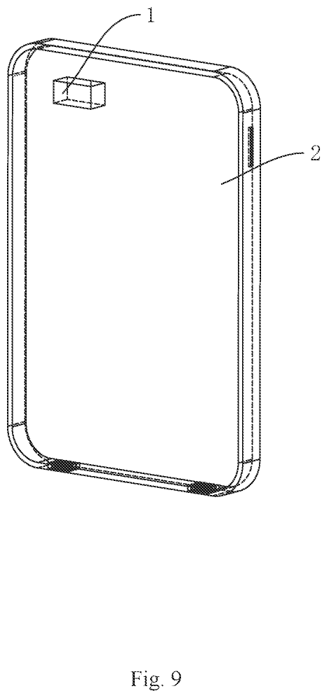

Referring to FIG. 9, an embodiment of the present invention further provides an electronic terminal, including a terminal body 2 and a lens drive device 1 as described in any of the above embodiments. In the lens drive device 1, the lens barrel 400 includes a first surface 402 connected to the elastic assembly 600 and close to the object side, and the holder 200 includes a second surface 201 connected to the elastic assembly 600 and close to the object side. The second surface 201 is closer to the object side than the first surface 402, so that the stroke of the lens barrel 400 in the direction of the object side becomes larger. The lens barrel 400 includes a third surface 403 connected to the elastic assembly 600 and close to the image side, and the holder 200 includes a fourth surface 202 connected to the elastic assembly 600 and close to the image side. The fourth surface 202 is closer to the image side than the third surface 403, so that the stroke of the lens barrel 400 in the direction of the image side becomes larger. Therefore, the whole stroke of the lens barrel 400 becomes larger and the lens drive device 1 in this embodiment has a better performance. Therefore, the electronic terminal in this embodiment has a better performance.

The above description is merely directed to some embodiments of the present invention, and it should be noted that for those of ordinary skill in the art, improvements can be made without departing from the inventive concept of the present invention, and these all fall within the scope of protection of the present invention.

What is claimed is:

1. A lens drive device, comprising:
a housing having a receiving space;
a holder received and fixed in the receiving space;
permanent magnets fixed to the holder;
a lens barrel for receiving a lens, the lens barrel being arranged in the holder in such a way that the lens barrel is movable in an optical axis direction of the lens;
a drive coil fitted over an outer peripheral face of the lens barrel and opposite the permanent magnets fixed to the holder;
an elastic assembly connected to the lens barrel and the holder separately and used for supporting the lens barrel to move in the optical axis direction; and
a circuit board assembly received and fixed in the receiving space and electrically connected to the drive coil,
wherein the lens barrel comprises a first surface connected to the elastic assembly and close to an object side, and the holder comprises a second surface connected to the elastic assembly and close to the object side, the second surface being closer to the object side than the first surface; and the lens barrel comprises a third surface connected to the elastic assembly and close to an image side, and the holder comprises a fourth surface connected to the elastic assembly and close to the image side, the fourth surface being closer to the image side than the third surface.

2. The lens drive device as described in claim 1, wherein the elastic assembly comprises an upper elastic piece and a lower elastic piece, wherein the upper elastic piece is connected to the lens barrel and the holder separately, and the lower elastic piece is connected to the lens barrel and the holder separately.

3. The lens drive device as described in claim 2, wherein the upper elastic piece comprises a first upper connection portion fixed to the second surface, a second upper connection portion fixed to the first surface, and an upper elastic arm for connecting the first upper connection portion and the second upper connection portion; and
the lower elastic piece comprises a first lower connection portion fixed to the fourth surface, a second lower connection portion fixed to the third surface, and a lower elastic arm for connecting the first lower connection portion and the second lower connection portion.

4. The lens drive device as described in claim 1, wherein the housing comprises a base and an upper cover covering and connected to the base, wherein the base and the upper cover enclose and form the receiving space; the circuit board assembly comprises a flexible printed circuit board (PCB) arranged on the base, and a PCB arranged on the flexible PCB in a stacked manner and electrically connected to the flexible PCB; and the flexible PCB is welded to the base.

5. The lens drive device as described in claim 4, wherein the flexible PCB is provided with a plated through hole electrically connected to the PCB.

6. The lens drive device as described in claim 4, further comprising an image stabilization coil electrically connected to the PCB, wherein the image stabilization coil is embedded inside the PCB and arranged opposite the permanent magnets, and the PCB is arranged in parallel with the base.

7. The lens drive device as described in claim 2, further comprising: a metal pin fixed to the housing and welded to the circuit board assembly; and a suspension wire for connecting the upper elastic piece and the metal pin.

8. The lens drive device as described in claim 7, wherein the metal pin is integrally formed with the housing.

9. The lens drive device as described in claim 1 further comprising a Hall sensor welded to the circuit board assembly and used for measuring an amount of movement of the lens.

10. An electronic terminal, comprising: a terminal body and the lens drive device as described in claim 1, wherein the lens drive device is arranged on the terminal body.

11. The lens drive device as described in claim 3, further comprising: a metal pin fixed to the housing and welded to the circuit board assembly; and a suspension wire for connecting the upper elastic piece and the metal pin.
